(19) United States
(12) Patent Application Publication
(10) Pub. No.: US 2024/0411922 A1
(43) Pub. Date: Dec. 12, 2024

(54) DATA CLASSIFICATION AND TRACKING SENSITIVE DATA ACCESSES

(71) Applicant: Acante, Inc., Saratoga, CA (US)

(72) Inventors: Udayakumar Srinivasan, Fremont, CA (US); Dhruv Hemchand Jain, Santa Clara, CA (US); Advait Abhay Dixit, Sunnyvale, CA (US); Abhishek Das, San Francisco, CA (US); Murali Bashyam, Fremont, CA (US); Jonathan L. Brisbin, Lamar, MO (US); Balaji Vasu, Fremont, CA (US); Georgios Karapanagos, San Francisco, CA (US)

(21) Appl. No.: 18/334,727

(22) Filed: Jun. 14, 2023

(30) Foreign Application Priority Data
Jun. 6, 2023 (GR) 20230100451

(51) Int. Cl. G06F 21/62

(52) U.S. Cl. CPC G06F 21/6245; G06F 21/6227

(57) ABSTRACT

A classifier component receives an instruction to determine whether any data fields in a datastore are sensitive data fields in which sensitive data is stored. The classifier component analyzes the set of data fields and determines that a data field is a sensitive data field. The classifier component causes information that classifies the data field as a sensitive data field to a data catalog without sending content of any data field in the set of data fields to the data catalog. A data security component subsequently accesses a query made to the datastore, the query including a data field name that identifies the data field. The data security component determines, based on the data catalog, that the query requested content from a sensitive data field, and stores, by the data security component, information that the query requested the content from the sensitive data field.

### RELATED APPLICATION

This application claims priority to Greek Patent Application No. 20230100451, filed on Jun. 6, 2023, entitled “DATA CLASSIFICATION AND TRACKING SENSITIVE DATA ACCESSES,” the disclosure of which is hereby incorporated herein by reference in its entirety.

### BACKGROUND

It is increasingly important for an operator of a data processing system to identify what sensitive data items, such as credit card numbers, drivers licenses, and the like are being collected and how such data items are being accessed.

### SUMMARY

The embodiments disclosed herein implement classification of datastores in a manner that eliminates the need to expose data to a human or provide access to the data to an entity executing outside of an environment controlled by the owner of the datastores, and that can be done repeatedly and efficiently in a short timeframe to ensure modifications and newly added datastores are promptly classified.

In one embodiment a method is provided. The method includes receiving, by a classifier component executing on one or more processor devices, an instruction to determine whether any data fields in a first datastore are sensitive data fields in which sensitive data is stored, the first datastore comprising a first data structure comprising a plurality of records, each record comprising a first set of data fields. The method further includes analyzing, by the classifier component, the first set of data fields and determining that at least one data field is a sensitive data field. The method further includes causing, by the classifier component, information that classifies the at least one data field as a sensitive data field to be stored in a data catalog without sending content of any data field in the first set of data fields to the data catalog. The method further includes subsequently accessing, by a data security component executing on the one or more processor devices, a query made to the first datastore, the query including a data field name that identifies the at least one data field. The method further includes determining, by the data security component based on the data catalog, that the query requested content from a sensitive data field. The method further includes storing, by the data security component, information that the query requested the content from the sensitive data field.

In another embodiment a computer system is provided. The computer system includes one or more computing devices operable to receive, by a classifier component executing on one or more processor devices, an instruction to determine whether any data fields in a first datastore are sensitive data fields in which sensitive data is stored, the first datastore comprising a first data structure comprising a plurality of records, each record comprising a first set of data fields. The one or more computing devices are further operable to analyze, by the classifier component, the first set of data fields and determine that at least one data field is a sensitive data field. The one or more computing devices are further operable to cause, by the classifier component, information that classifies the at least one data field as a sensitive data field to be stored in a data catalog without sending content of any data field in the first set of data fields to the data catalog. The one or more computing devices are further operable to subsequently access, by a data security component executing on the one or more processor devices, a query made to the first datastore, the query including a data field name that identifies the at least one data field. The one or more computing devices are further operable to determine, by the data security component based on the data catalog, that the query requested content from a sensitive data field, store, by the data security component, information that the query requested the content from the sensitive data field.

In another embodiment a non-transitory computer-readable storage medium that includes executable instructions operable to cause one or more computing devices to receive, by a classifier component executing on one or more processor devices, an instruction to determine whether any data fields in a first datastore are sensitive data fields in which sensitive data is stored, the first datastore comprising a first data structure comprising a plurality of records, each record comprising a first set of data fields. The instructions are further operable to cause the one or more computing devices to analyze, by the classifier component, the first set of data fields and determine that at least one data field is a sensitive data field. The instructions are further operable to cause the one or more computing devices to cause, by the classifier component, information that classifies the at least one data field as a sensitive data field to be stored in a data catalog without sending content of any data field in the first set of data fields to the data catalog. The instructions are further operable to cause the one or more computing devices to subsequently access, by a data security component executing on the one or more processor devices, a query made to the first datastore, the query including a data field name that identifies the at least one data field. The instructions are further operable to cause the one or more computing devices to determine, by the data security component based on the data catalog, that the query requested content from a sensitive data field, store, by the data security component, information that the query requested the content from the sensitive data field.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which data classification and tracking sensitive data accesses can be practiced according to one embodiment;

FIG. 2 illustrates a security token according to one embodiment;

FIG. 3 is a block diagram of an environment in which data classification and tracking sensitive data accesses can be practiced according to another embodiment;

FIG. 4 is a flowchart of a method for data classification and tracking sensitive data accesses according to one embodiment;

FIG. 5 is a block diagram of an environment for visualizing data according to another embodiment;

FIG. 6 is a block diagram of a computing device suitable for executing any of the components discussed herein; and

FIG. 7 is a user interface generated by a visualizer component according to one embodiment.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Businesses, individuals and governments are increasingly concerned about the protection of sensitive data, such as social security numbers, driver license numbers, addresses, credit card numbers, and the like. Such sensitive data can be used by individuals to defraud credit card companies, hijack an individual's identity, and the like.

Software systems are increasingly developed using relatively “small” components sometimes referred to as micro-services. There are many advantages to a micro-service architecture approach to application development, such as ease of maintenance, ability to use certain services in different applications with little or no modifications, an ability to spread services across different computing devices for load balancing purposes, and the ability to scale at a service level. A micro-service architecture may be implemented via any number of different technologies including, by way of non-limiting example, cloud-native technologies such as containers and serverless functions. For purposes of brevity, the term “service” may used herein to refer to micro-services.

Software systems also increasingly utilize multiple datastores, such as Structured Query Language (SQL) databases, Amazon AWS® buckets, and other forms of data storage. It is not uncommon for a complex software system to utilize tens or hundreds of different datastores. Developers of the software system may add new datastores to enhance functionality, or modify existing datastores to store additional information that was not previously stored on an ad-hoc and relatively frequent basis. It is difficult or even impractical at times for a software system operator to know the sensitive data that may be stored in the various datastores. Having a human painstakingly categorize each data field may take a substantial amount of time and may be a full-time endeavor. Moreover, having a human categorize data fields would expose the human to sensitive data which could in itself cause a data breach.

As security has become increasingly important, it is now common for an application to require electronic credentials, such as a security token, that identifies and authorizes a transaction originator of a transaction prior to processing the transaction. Such tokens may be obtained by an originator from an identity provider, such as Microsoft®, Okta®, or the like, who validates an originator's identity and generates a security token that is signed by the identity provider. The entry point into the application, such as a validating service, may receive the security token, ensure that the signature of the identity provider is correct, and then begin processing the transaction in accordance with the privileges identified in the security token.

It is common that, once the transaction has been accepted, the security token is not passed along from service to service because there is typically no reason to do so since it has been determined that the transaction has been authorized to be processed by the application.

Each service in the application may invoke (e.g., access) other information sources such as, by way of non-limiting example, another internal service or external service, a datastore, a data file, or the like. Services may send sensitive data to, and/or receive sensitive data from, such information sources. Unfortunately, even if it is determined that such sensitive data has been received or sent by a service, it can be difficult or impossible to correlate the sensitive data with a particular transaction, or with an originator of the transaction.

The embodiments disclosed herein implement classification of datastores in a manner that eliminates the need to expose data to a human or to provide access to the data to an entity executing outside of an environment controlled by the owner of the datastores, and that can be done repeatedly and efficiently in a short timeframe to ensure modifications and newly added datastores are promptly classified. The embodiments also identify queries made to datastores and correlate the queries with data fields that have been classified as sensitive data fields to determine which queries requested sensitive content from a datastore. The embodiments may identify for such queries the entities associated with the queries.

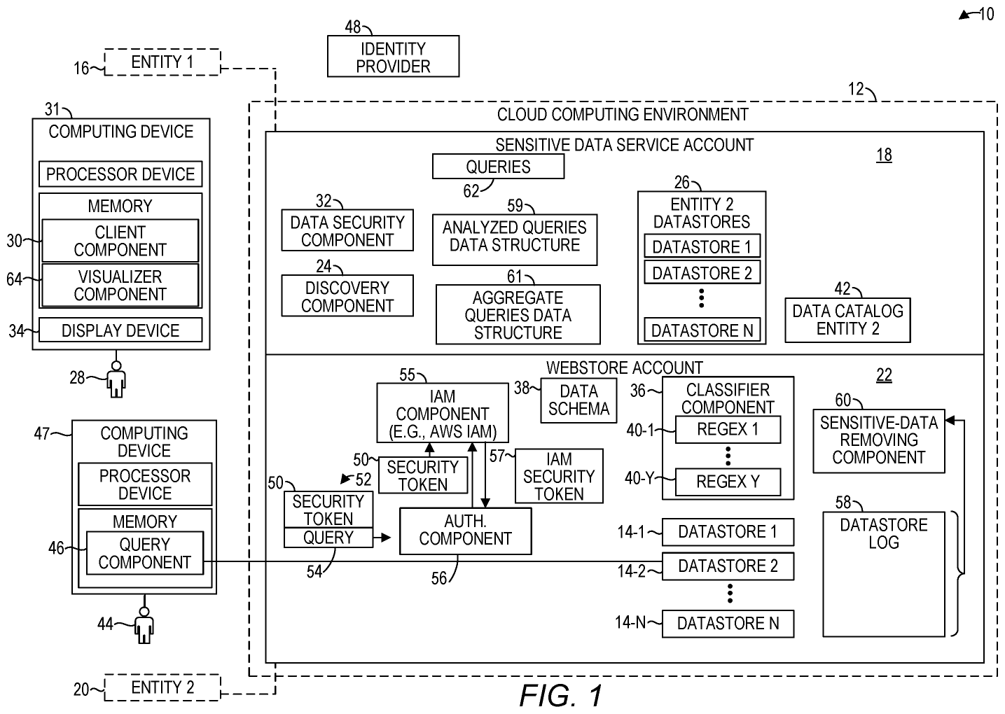

FIG. 1 is a block diagram of an environment 10 in which data classification and tracking sensitive data accesses can be practiced according to one embodiment. In this embodiment, the environment 10 includes a cloud computing environment 12. The cloud computing environment 12 may comprise any suitable cloud computing environment, such as Amazon AWS®, Google Cloud®, Microsoft Azure®, or the like. An entity, such as a service provider, operates a plurality of datastores 14-1-14-N (generally, datastores 14). The term “datastore” are used herein refers to any structure that operates to store data, including, by way of non-limiting examples, a file, a database, a database table, a SQL database, a SQL database table, an AWS® bucket, or the like.

Each datastore 14 may comprise a plurality of records that contain a same set of data fields. The term data field refers to a portion of a record in a datastore. The term “content” or “data item”, as used herein, refers to the actual data that is stored in a data field. For example, a Name data field of a first record in the datastore 14-1 may store the name “Bob Johnson”. “Bob Johnson” is the content of the Name data field for the first record, and may also be referred to as the data item of the Name data field for the first record. The Name data field of a second record in the datastore 14-1 may store the name “John Smith”. Thus, the data fields are the same in each record of the datastore 14-1, but the data items (i.e., content) of the data fields may differ from record to record. Solely as an example, the datastore 14-1 may be a “customer” datastore and may include a set of data fields such as a Name data field, an address data field, a city data field, a state data field, and a zipcode data field. The datastores 14 may number in the hundreds or thousands.

The cloud computing environment 12 implements restricted computing environments that separate (e.g., isolate) components of different entities through some authentication mechanism such that a component associated with a first entity cannot access components or datastores of a second entity without the second entity providing the first entity explicit authorization to do so. In this example, the authentication/restriction mechanism will be referred to as an account, such that components running in one account cannot access or otherwise communicate with components in another account without permission.

The term “component” as used herein refers to an executing process and may comprise any type of running process. While not illustrated for purposes of simplicity, the cloud computing environment executes the components on computing devices, and thus each component illustrated in the Figures is executing on a computing device that includes one or more processor devices. The components may be running on the same computing device or may be distributed across multiple computing devices to form a computer system, and thus collectively, the components run on one or more processor devices that are associated with one or more computing devices of a computer system. Different components executing on the same computing device may be executing in different accounts and thus be isolated from one another.

In this embodiment, a first entity 16 associated with (e.g., owns and operates) a sensitive data services account 18 provides at-rest data classification and tracking sensitive data accesses services to a plurality of other entities, including, in this example, an entity 20, such as a business, associated with a webstore account 22. The sensitive data service account 18 includes a discovery component 24 that identifies the datastores 14-1-14-N in the webstore account 22 and generates a list 26 that contains datastore identifiers of the datastores 14-1-14-N. In some embodiments, the entity 20 may grant the discovery component 24 limited rights that allow the discovery component 24 to request a list of the datastores 14 but has no authorization to access the datastores 14, and thus the discovery component 24 cannot read or write to any of the datastores 14. In other embodiments, the entity 20 may simply provide, to the discovery component 24, the list 26 of the datastores 14 as a data file or the like.

A data security component 32 may subsequently access the list 26 of datastores 14 and communicate with a client component 30 executing on a computing device 31 to cause the client component 30 to present user interface imagery that identifies the datastores 14 in the list 26 on a display device 34 to a user 28 who is associated with the entity 20. The user 28 may select one or more of the datastores 14 to have such datastores analyzed, and have the data fields of the selected datastores 14 classified. In this example, assume that the user 28 selects the datastore 14-2. The data security component 32 receives the input and sends an instruction to a classifier component 36 to determine whether any data fields in the datastore 14-2 should be classified as sensitive data fields. The classification system may be relatively simple, such as sensitive or not sensitive, or may be more granular and include sensitive data categorizations and sensitive data sub-categorizations. As an example, a sensitive data categorization may be a “Personally Identifiable Information (PII)” type sensitive data. A PII type sensitive data may be further sub-categorized as a name type sensitive data, an address type sensitive data, a credit card number type sensitive data, a driver's license identifier type sensitive data, a social security number type sensitive data, and the like.

In some embodiments, the data security component 32 may have limited access rights that include an ability to send the instruction to the classifier component 36. In other embodiments, the data security component 32 may send the instruction indirectly to the classifier component 36 by, for example, storing the instruction in a common area, such as a file, that is accessible to both the data security component 32 and the classifier component 36 such that there are no direct communications between the data security component 32 and the classifier component 36. The classifier component 36 may periodically, intermittently, or in response to some event access the file to determine if the data security component 32 has provided new instructions for the classifier component 36.

The classifier component 36 has been granted the rights to execute in the webstore account 22, and thus can access the datastore 14-2, but in some embodiments the classifier component 36 does not provide the contents of any data fields (i.e., any data items) to any component executing outside of the webstore account 22, including any component executing in the sensitive data service account 18.

In response to the instruction, the classifier component 36 analyzes the datastore 14-2. In one embodiment, the classifier component 36 analyzes a datastore schema 38 that identifies the data field names of the data fields that compose a record of the datastore 14-2. The schema 38 provides information that allows the classifier component 36 to read and understand the content of the records of the datastore 14-2. The classifier component 36 may read a subset of the records of the datastore 14-2 and determine whether data items should be classified as sensitive data items. As an example, the datastore 14-2 may comprise 1,000,000 records and the classifier component 36 may read 1000 records. The number of records to read may, for example, be predetermined, may be some percentage of the total number of records, or may be provided in the instruction from the data security component 32.

The classifier component 36 may process the data items from the subset of records with one or more of a plurality of different regular expressions (REGEXs) 40-1-40-Y (generally, REGEXs 40) to identify sensitive data items. Each REGEX 40 may be designed to determine whether a data item has a pattern that matches a particular sensitive data item type. For example, the REGEX 40-1 may determine that a data item having a pattern of xxx-xx-xxxx is a sensitive data item of type social security number. The classifier component 36 may require that some percentage of the data items that correspond to the same data field from each of the subset of records match the REGEX 40 in order to classify the corresponding data field as a sensitive data field. The classifier component 36 causes information that classifies the data fields in the set of data fields that makes up a record in the datastore 14-2 as sensitive data fields or non-sensitive data fields to be stored in a data catalog 42 in the sensitive data service account 18. Notably, the classifier component 36 does not send any data items or other content stored in the datastore 14-2 to the data catalog 42. The classifier component 36 may be given read and write access to the data catalog 42 and may store the information directly, or, for example, may store the data in a data structure, such as a data file, and a component executing in the sensitive data service account 18 may extract the information from the data structure and store the information in the data catalog 42.

In some embodiments, a dictionary of common names or terms (e.g., partial words) may be maintained and also used by the classifier component 36 to determine whether a data field should be classified as a sensitive data field. For example, in addition to processing the data items with REGEXs as described above, the classifier component 36 may determine if a data item name obtained from the datastore schema 38 matches or contains a name or term in the dictionary, and if so, the classifier component 36 may use this to bolster the confidence that a data field should be classified as a sensitive data field. For example, a data field may be determined by the REGEXs to contain social security numbers, and the data field name obtained from the datastore schema 38 may be SOC-SEC-NUM. The dictionary may identify “SOC”, “SEC” and “NUM” as names or components of names of potentially sensitive data fields. The classifier component 36 may determine then with a high probability that the data field is used to store social security numbers.

This process may be repeated for any additional datastores 14 selected by the user 28. In some embodiments, each datastore 14 may automatically be classified by the classifier component 36.

For purposes of illustration, assume that a user 44 desires to make a query against the datastore 14-2. In some embodiments, prior to doing so, the user 44 must obtain a security token that indicates that the user 44 is authorized to query the datastore 14-2. A query component 46 executing on a computing device 47 sends a request to an identity provider 48 for a security token 50.

The identity provider 48 may be operated by a trusted entity such as Microsoft®, Okta®, or the like that validates (or does not validate) a transaction originator's request for a security token. The validation may depend on whatever criteria the identity provider 48 requires, such as valid authentication credentials, or the like. In this example, assume that the request contains appropriate authentication information, such as a user identifier and password of the user 44, and the identity provider 48 determines that the user 44 is authorized to access the datastore 14-2. The identity provider 48 generates the security token 50 that indicates that the user 44 is authorized to access the datastore 14-2 and sends the security token 50 to the transaction originator. The security token 50 contains information associated with the user 44, such as an identity of the user 44 and the identity of the computing device 47. The identity provider 48 may also digitally sign the security token 50 with a digital signature of the identity provider 48.

The query component 46, in response to input from the user 44, generates a message 52 that includes a query 54 and the security token 50 and sends the message 52 towards the datastore 14-2. An authentication component 56 may first receive the message 52 and send the the security token 50 to an Identity and Access Management (IAM) component 55 that authenticates and authorizes the transaction based on the security token 50. The IAM component 55 may issue a security token 57 that includes the content of the security token 50 and includes access control rights for the transaction. The authentication component 56 may store the security token 57 along with a generated transaction identifier in a data structure so that the query 54 can subsequently be associated with the user 44. The authentication component 56 may also correlate the transaction with a user identifier (e.g., an email address or the like) and/or the computing device (e.g., the computing device 47) originating the query such as by Internet protocol (IP) address or other identifying information that identifies the computing device. The authentication component 56 may then send the transaction identifier and the query 54 to the datastore 14-2 for processing. The datastore 14-2 stores the query 54 and the transaction identifier and a timestamp in a query repository, such as a datastore log 58. The query 54 includes one or more data field names, one or more parameters, and one or more conditions with respect to the data field names and the parameters that identifies the records that match the query.

For example, the query 54 may comprise “RETURN SOC-SEC-NUM WHERE STATE=‘OHIO’”. The data field names used in the query 54 are “SOC-SEC-NUM” and “STATE”, the parameter is “Ohio”, and the condition is “=”. The records that match the query are those records where the STATE data field contains the value “OHIO”. From those records, the social security number is extracted and provided to the query component 46.

A sensitive-data removing component 60 executing in the webstore account 22 accesses the query 54 in the datastore log 58. The sensitive-data removing component 60 parses the query 54 to identify the data field names, the parameters, and the conditions used in the query 54. The sensitive-data removing component 60 removes all parameters from the query 54. The sensitive-data removing component 60 sends the query 54 to the data security component 32. In this manner, the sensitive-data removing component 60 ensures that no data items that may have been used as parameters are provided outside of the webstore account 22. The sensitive-data removing component 60 may also provide the security token 57 to the data security component 32, or information extracted from the security token 57 that identifies the user 44.

The data security component 32 may store the queries and security tokens in a query data structure 62. The data security component 32 parses the query 54 to identify the data fields used in the query 54. The data security component 32 accesses the data catalog 42 to determine whether any such data fields are sensitive data fields. The data security component 32 can determine what datastores 14 were accessed by the query 54, which data fields were accessed by the query 54, and the identities of the user 44 and the computing device 47 via the security token 57. For each such analyzed query, the data security component 32 may store the results in an entry of an analyzed queries data structure 59. Each entry may include, for example, a user identifier, a computer identifier, a timestamp of the query, data field names of the data fields accessed by the query, data field names of the data fields returned by the query, and sensitive data categorizations and sensitive data sub-categorizations of each such data field. Periodically, or on demand, the data security component 32 may aggregate the entries in the analyzed queries data structure 59 to generate aggregrate query records that may be stored in an aggregrate queries data structure 61. The aggregrate query records may aggregate over any desired period of time and over any desired criteria or criterion, such as by datastore, by user, by sensitive data categorization or sensitive data sub-categorization, or the like.

It is noted that the process described above with regard to the sensitive-data removing component 60 and the data security component 32 may be repeated hundreds or thousands of times each minute depending on the volume of queries to the datastores 14. The data security component 32 can aggregate information from hundreds, thousands, or millions of queries and provide aggregate information regarding who accessed which sensitive data fields.

The user 28 may use a visualizer component 64 to access the analyzed queries data structure 59 and/or aggregrate queries data structure 61 and generate user interfaces that provide information to the user 28, such as information on who, how, when, and what type of information was accessed for each data access. The “who” may include, by way of non-limiting example, a username, an email address, an associated IAM role of the user, groups to which the user belongs, an IP address of the originating computing device, and the like. The “how” may include, by way of non-limiting example, information on servers, applications, application programming interfaces (APIs), and the like. Each such access may also be timestamped. The information can include the particular datastore that has been accessed, the data class, the database type, and the like. The number of records and/or objects that were read and written may also be logged and visualized. The information may be aggregated across hours, days, or any other timeframe to present an aggregated view of the accesses. A user can then query the data using various filters, such as, by way of non-limiting example, by datastore, by role, by user, or the like. As discussed above, the visualizer component 64 may access the aggregrate queries data structure 61 to visualize analyzed queries that have been aggregated based on some criteria or criterion such as a desired period of time, a particular datastore, a particular user, particular sensitive data categorizations or sensitive data sub-categorizations, or the like.

It is noted that while various functionality is attributed to certain components illustrated herein, in other implementations such functionality could be implemented via a greater number of components, or a fewer number of components. For example, the data security component 32 and the discovery component 24 could be implemented in a single component or could be implemented in more than two components.

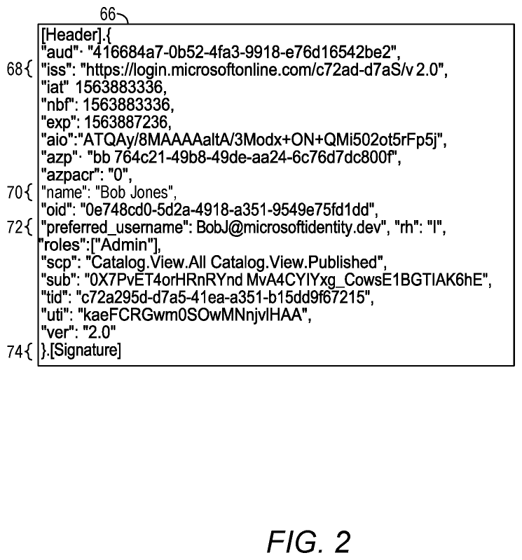

FIG. 2 illustrates a security token 66 according to one embodiment. The security token 66 may contain an issuer claim 68 that identifies the principal that issued the security token, in this example, the identity provider 48. The security token 66 may also contain a name key-value pair 70 that identifies the entity associated with the transaction, in this example, the user 44. The security token 66 may also contain a preferred name key-value pair 72 that identifies an email address associated with the entity associated with the transaction. The security token 66 may also contain a digital signature 74 of the identity provider 20. The sensitive-data removing component 60 may extract any of the information contained in the security token 66, including the entire contents of the security token 66, and send the information to the data security component 32 to correlate the query 54 with the security token 66, and thus to the user 24.

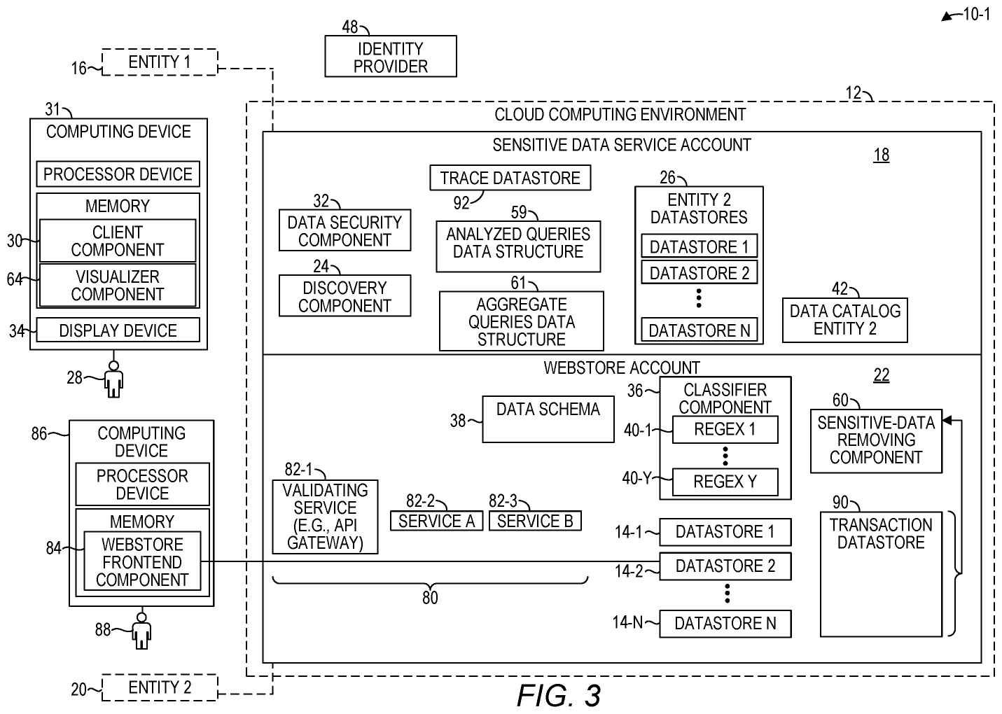

FIG. 3 is a block diagram of an environment 10-1 in which data classification and tracking sensitive data accesses can be practiced according to another embodiment. The environment 10-1 is substantially similar to the environment 10 except as otherwise noted herein. In this embodiment, the webstore account 22 includes an application 80 made up of a plurality of micro-services 82-1-82-3 (hereinafter “services 82-1-82-3” and generally, services 82). The term “micro” in the phrase “micro-service” refers to the fact that the application 80 comprises multiple different services, and does not imply a particular programming language or application architecture. Collectively, the services 82 compose the application 80. In some implementations, the application 80 comprises a cloud-native application, and the services 82 may comprise, for example, serverless functions, or containers that communicate with one another via one or more networks. In some embodiments, the services 82 may run in a container orchestration system, such as Kubernetes, and may comprise pods. While not illustrated due to space limitations, each of the services 82 executes on computing devices that include memory and one or more processor devices. The services 82 may execute on the same computing device, or may execute on multiple computing devices. While only three services 82 are illustrated for purposes of explanation and simplicity, in practice, the application 80 may comprise tens or hundreds of services 82.

The services 82 communicate with one another using any desired inter-process communication (IPC) mechanism, such as, by way of non-limiting examples, one or more of message queues, files, a RESTful API, service mesh IPC mechanisms, or the like. Although in the embodiments discussed herein the application 80 provides an online webstore functionality, the embodiments are not limited to any particular application functionality and have applicability to any application comprising a micro-service architecture.

The application 80 includes one or more validating services 82-1, which receive transactions from transaction originators. The validating service 82-1, in this example, is a gateway API validating service into the application 80, but in other implementations, the validating service 82-1 may not be a gateway API service. Moreover, while for purposes of convenience the validating service 82-1 is illustrated as a single service 82, in other implementations, multiple services 82 may operate to provide the functionality attributed herein to the validating service 82-1. The application 80 may be configured to deny any transaction that is not first provided to the validating service 82-1. The validating service 82-1, prior to allowing the application 80 to process a transaction, may validate that the entity submitting the transaction has the authority to do so.

In this example, a webstore frontend component 84 executing on a computing device 86 initially sends a request to the identity provider 48 to obtain a security token in response to an input from a user 88. In this example, assume that the request contains appropriate authentication information, such as a user identifier and password of an entity, such as the user 88, and the identity provider 48 determines that the webstore frontend component 84 is authorized to access the application 80. Based on the authentication information, the identity provider 48 generates a message (referred to herein as a security token) that indicates that the webstore frontend component 84 is authorized to access the application 80 and sends the security token to the webstore frontend component 84. The security token contains information associated with the webstore frontend component 84, such as an identity of the entity, such as the user 88, and/or the identity of the computing device 86. The security token may also include permitted actions with respect to the application 80. The identity provider 48 may also digitally sign the security token with a digital signature of the identity provider 48.

The webstore frontend component 84 receives the security token and sends a transaction and the security token to the validating service 82-1. The validating service 82-1 receives the transaction and the security token indicating that the webstore frontend component 84 is authorized to submit the transaction to the application 80. The validating service 82-1 may validate the digital signature of the security token.

The validating service 82-1 obtains a transaction identifier (ID) that uniquely identifies the transaction. In some embodiments, the webstore frontend component 84 may provide the transaction ID. In some embodiments, a module between the webstore frontend component 84 and the validating service 82-1 may generate the transaction ID, and the transaction ID may accompany the transaction. In other embodiments, the validating service 82-1 may generate the transaction ID. In other embodiments, the validating service 82-1 may invoke a transaction identifier generation service to obtain the transaction ID.

The validating service 82-1 causes a message that includes the transaction ID and data derived from the security token to be sent to a transaction datastore 90. The data may include any desired information contained in the security token, including, by way of non-limiting example, information that identifies the entity that caused the transaction to be submitted to the application 80. In this example, the information includes the name of the user 88. The data may also identify certain access rights that the user 88 may have, and/or certain access rights that the user 88 does not have. Examples of a security token are illustrated above with regard to FIG. 2.

The transaction datastore 90 receives the transaction ID and the data, generates a record, and stores the record. The record correlates the transaction ID with the user 88. The transaction datastore 90, or another service 82, may determine that more information may be necessary and/or desired than is provided in the security token. The transaction datastore 90 may then use information in the security token to interface with an Identity and Access Management (IAM) provider to obtain additional information about the webstore frontend component 84. Such additional information may include, by way of non-limiting example, a client application identifier, a user identifier, a group identifier, roles, privileges granted for the specific transaction, an Internet protocol (IP) address, a geolocation of the webstore frontend component 84, and what policies enabled the initiation of the transaction. The transaction datastore 90 stores such information in conjunction with the transaction ID.

The validating service 82-1 may now begin to process the transaction. In this example, the services 82 comprise services that utilize a RESTful API (sometimes referred to as a REST API) to communicate with one another. The validating service 82-1 invokes a particular API entrypoint of the service 82-2 using a hypertext transfer protocol (HTTP) GET request and provides, in conjunction with the invocation, the transaction ID. The transaction ID may be provided as a parameter in the HTTP GET request, or in a header of the HTTP GET request, or via any other suitable manner in conjunction with the HTTP GET request. The term “invoke” as used herein refers to any mechanism for accessing, transferring control, or otherwise communicating between a first entity, such as a service, and a second entity. The term “invoke” may also be referred to as a request. By way of non-limiting example, invoking can refer to the invocation of a method of the second entity, such as a Java method, can refer to a message passed to a datastore, can refer to the reading of a file, can refer to the invocation of an API entrypoint, or can refer to the insertion of a message into a message queue.

One or more, or each, of the services 82 may cause the transaction ID and metadata about an invocation to be sent to the transaction datastore 90 upon the occurrence of certain events, such as, by way of non-limiting example, when an information source, such as the respective service 82, is invoked, when the respective service 82 invokes another information source, and/or when a service 82 receives a response from an invoked service 82. The information generated and sent to the transaction datastore 90 may be referred to herein as a trace. One or more, or each, of the services 82 may also cause traces that contain metadata about information contained in a response and that contain the transaction ID to be sent to the transaction datastore 90 upon receiving a response from an invoked datastore or service 82. The term “cause” as used herein refers to an actor directly or indirectly performing an action. For example, in this context, the service 82 may directly send metadata and the transaction ID to the transaction datastore 90, or may indirectly send the metadata and the transaction ID to the transaction datastore 90. For example, the service 82 may send a trace regarding an invocation or a response, including the transaction ID, to an intermediary service that first processes the information to generate the metadata and then sends the metadata and the transaction ID to the transaction datastore 90, such that the service 82 caused the metadata and the transaction ID to be sent to the transaction datastore 90. In some implementations, the transaction ID and the metadata may be generated and sent by a distributed tracing technology, such as, by way of non-limiting example, Jaeger or DataDog.

Prior to or subsequent to the validating service 82-1 invoking the particular API entrypoint of the service 82-2, the service 82-1 may generate a trace that includes the transaction ID and metadata associated with (M.A.W.) the invocation of the service 82-2, such as the actual API entry point of the service 82-2 invoked by the validating service 82-1, and metadata about the data provided in the HTTP GET request. The validating service 82-1 sends the trace to the transaction datastore 90.

An invoked service 82 may be referred to as a downstream service 82 with respect to the invoking service 82. The invocation of the service 82-2 is a request that includes input data associated with the transaction that is provided by the invoking service 82-1 in the HTTP GET request. The input data includes the transaction ID. Although not illustrated due to spatial considerations and ease of explanation, each invoked service 82 may also generate a message that includes the transaction ID and metadata associated with (M.A.W.) the invocation of the service 82, such as the actual API entry point of the service 82 invoked by the upstream service 82, and metadata about the data provided in the HTTP GET request, and the like. The invoked service 82 may then send the trace to the transaction datastore 90.

In this example, the service 82-2 may perform certain processing and determine that information, in the form of one or more data items, needs to be obtained from a datastore 14 to provide a response to the invoking service 82-1. In this example, the datastore 14-1 is accessed.

Prior to or subsequent to sending a query to the datastore 14-1, the service 82-2 may generate a trace that includes the query that is made to the 14-1, as described above with regard to FIG. 1. The invoking service 82-2 may initiate certain processing based on the response from the datastore 14-1 and return a response to the validating service 82-1. The response may include data items obtained from the datastore 14-1 in response to the query.

The validating service 82-1 may generate a trace that includes the transaction ID and metadata associated with the response from the service 82-2, and send the trace to the transaction datastore 90. The validating service 82-1 may generate a response to return to the webstore frontend component 84. The validating service 82-1 may then generate a trace that identifies the types and quantities of sensitive data items identified via the REGEX processing that were returned to the webstore frontend component 84.

The sensitive-data removing component 60 may access the transaction datastore 90 and perform similar processing as described above to remove all parameters and any other data items from the traces. The data removing component 60 may then send the traces, the transaction ID, and the security token to the data security component 32 for storage in a trace datastore 92. The data security component 32 can then identify each service 82 that was invoked in a transaction, the particular APIs of each service 82 that were invoked, any queries that were made to any datastores 14 by the services 82, and the actual sensitive data fields and quantities of data items (but not the content of the data items) that the validating service 82-1 returned to the webstore frontend component 84.

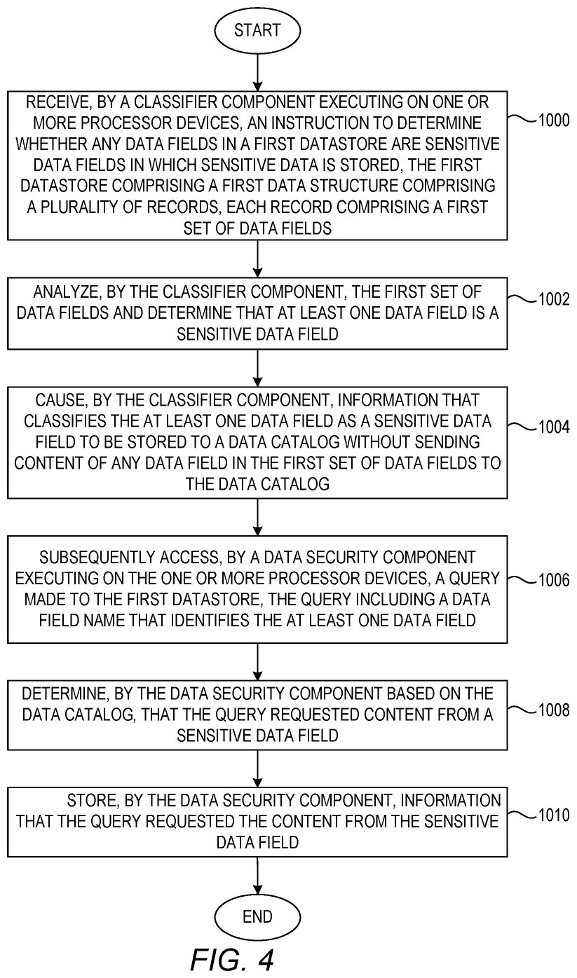

FIG. 4 is a flowchart of a method for data classification and tracking sensitive data accesses according to one embodiment. FIG. 4 will be discussed in conjunction with FIG. 1. The classifier component 36, executing on a processor device, receives an instruction to determine whether any data fields in the datastore 14-2 are sensitive data fields in which sensitive data is stored, the datastore 14-2 comprising a data structure comprising a plurality of records, each record comprising a set of data fields (FIG. 4, block 1000). The classifier component 36 analyzes the first set of data fields and determines that at least one data field is a sensitive data field (FIG. 4, block 1002). The classifier component 36 causes information that classifies the at least one data field as a sensitive data field to be stored to a data catalog without sending content of any data field in the first set of data fields to the data catalog (FIG. 4, block 1004). The data security component 32, executing on a processor device, subsequently accesses a query made to the datastore 14-2, the query including a data field name that identifies the at least one data field (FIG. 4, block 1006). The data security component 32 determines, based on the data catalog 42, that the query requested content from a sensitive data field (FIG. 4, block 1008). The data security component 32 stores information that the query requested the content from the sensitive data field (FIG. 4, block 1010).

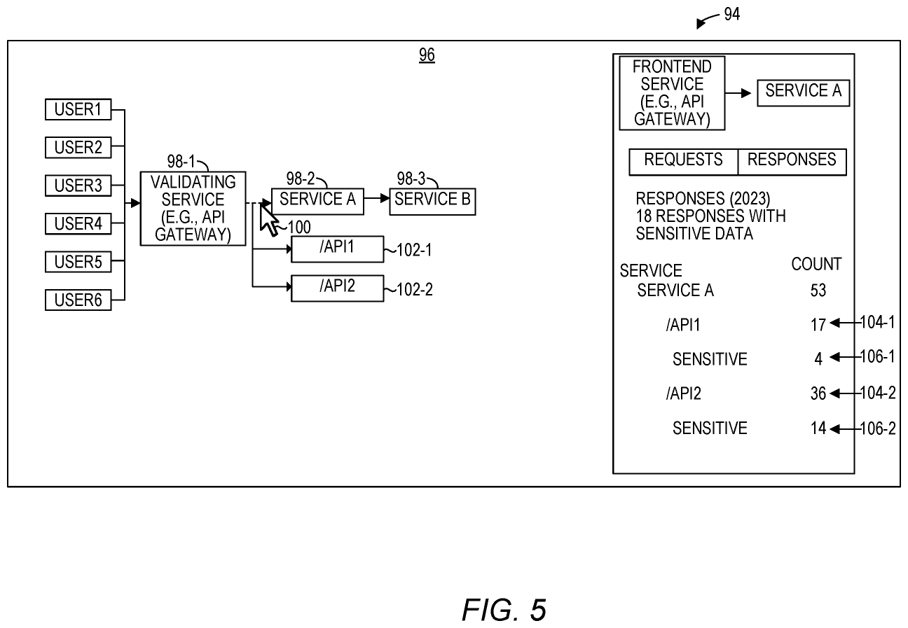

FIG. 5 is a block diagram of an environment 94 for visualizing data according to another embodiment. In this example, the visualizer component 64 accesses the trace records stored in the trace datastore 92 and, based on the trace records, presents, on the display device 34, user interface imagery 96 that depicts symbols 98-1-98-3 that correspond to the plurality of services 82. The visualizer component 64 receives a user input selection 100 that corresponds to a particular service, in this example, the service 82-2 that corresponds to the symbol 98-2. The visualizer component 64, based on the trace records, determines a plurality of functions of the service 82-2 that were invoked by an invoking service 82. The visualizer component 64 supplements the user interface imagery 96 on the display device 34 to identify a plurality of functions 102-1 and 102-2 of the service 82-2 that were invoked by an invoking service 82. In this example, two functions API1 and API2 were invoked by an invoking service 82. The visualizer component 64 supplements the user interface imagery 96 to include counts 104-1 and 104-2 of responses returned by the functions API1 and API2, and counts 106-1 and 106-2 of the number of such responses that included sensitive data.

Because the visualizer component 64 is a component of the computing device 31, functionality implemented by the visualizer component 64 may be attributed to the computing device 31 generally. Moreover, in examples where the visualizer component 64 comprises software instructions that program a processor device to carry out functionality discussed herein, functionality implemented by the visualizer component 64 may be attributed herein to such processor device.

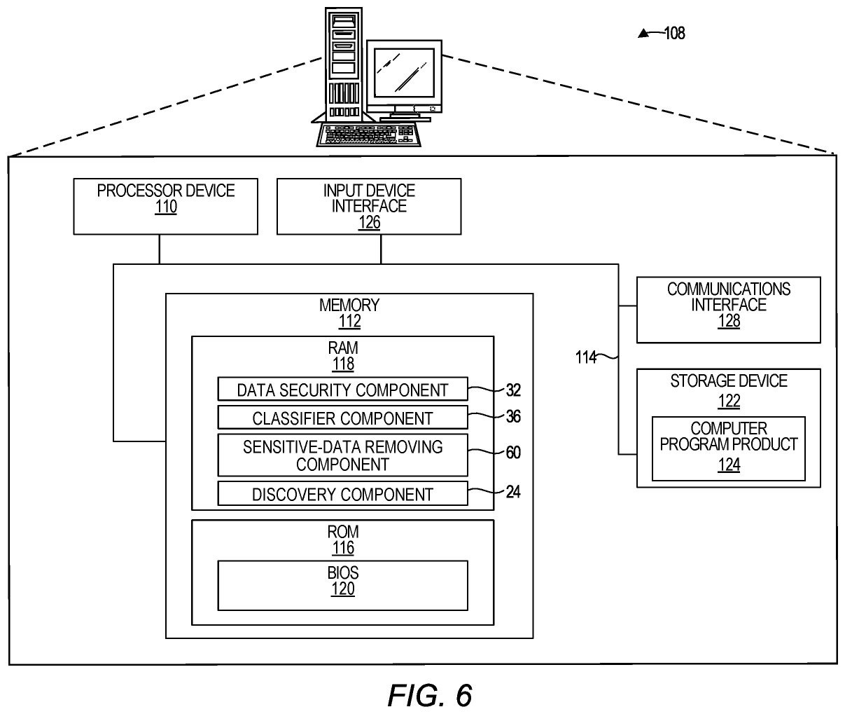

FIG. 6 is a block diagram of a computing device 108 suitable for executing any of the components discussed herein. The computing device 108 may comprise any computing or electronic device capable of including firmware, hardware, and/or executing software instructions to implement the functionality described herein, such as a computer server, or the like. The computing device 108 includes a processor device 110, the system memory 112, and a system bus 114. The system bus 114 provides an interface for system components including, but not limited to, the system memory 112 and the processor device 110. The processor device 110 can be any commercially available or proprietary processor.

The system bus 114 may be any of several types of bus structures that may further interconnect to a memory bus (with or without a memory controller), a peripheral bus, and/or a local bus using any of a variety of commercially available bus architectures. The system memory 112 may include non-volatile memory 116 (e.g., read-only memory (ROM), erasable programmable read-only memory (EPROM), electrically erasable programmable read-only memory (EEPROM), etc.), and volatile memory 118 (e.g., random-access memory (RAM)). A basic input/output system (BIOS) 120 may be stored in the non-volatile memory 116 and can include the basic routines that help to transfer information between elements within the computing device 108. The volatile memory 118 may also include a high-speed RAM, such as static RAM, for caching data.

The computing device 108 may further include or be coupled to a non-transitory computer-readable storage medium such as a storage device 122, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 122 and other drives associated with computer-readable media and computer-usable media may provide non-volatile storage of data, data structures, computer-executable instructions, and the like.

A number of modules can be stored in the storage device 122 and in the volatile memory 118, including an operating system and one or more program modules, such as the data security component 32, the classifier component 36, the discovery component 24, or the sensitive-data removing component 60, which may implement the functionality described herein in whole or in part. All or a portion of the examples may be implemented as a computer program product 124 stored on a transitory or non-transitory computer-usable or computer-readable storage medium, such as the storage device 122, which includes complex programming instructions, such as complex computer-readable program code, to cause the processor device 110 to carry out the steps described herein. Thus, the computer-readable program code can comprise software instructions for implementing the functionality of the examples described herein when executed on the processor device 110. The processor device 110, in conjunction with the components 24, 32, 36, or 60, may serve as a controller, or control system, for the computing device 108 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 110 through an input device interface 126 that is coupled to the system bus 114 but can be connected by other interfaces such as a parallel port, an Institute of Electrical and Electronic Engineers (IEEE) 1394 serial port, a Universal Serial Bus (USB) port, an IR interface, and the like. The computing device 108 may also include a communications interface 128 suitable for communicating with a network as appropriate or desired.

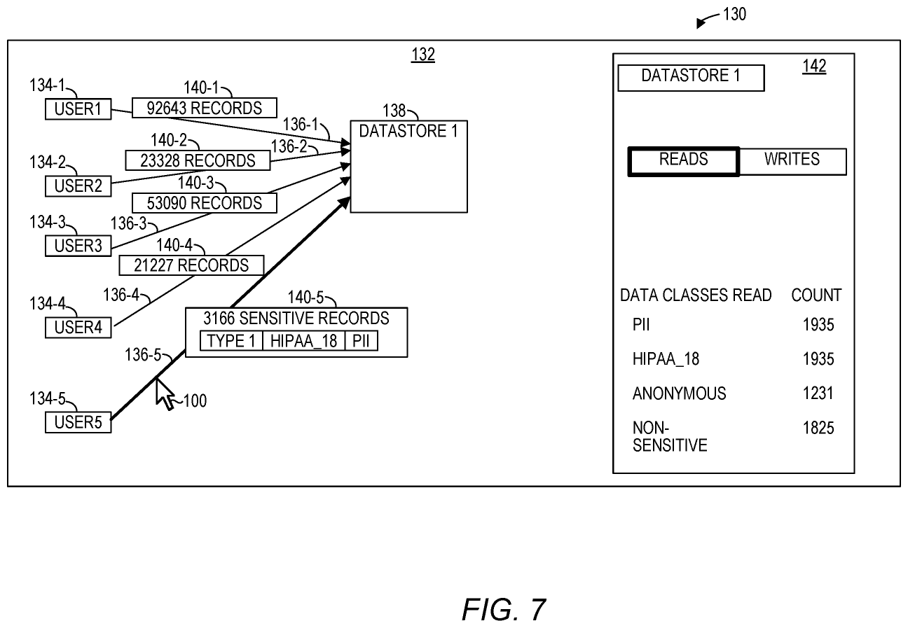

FIG. 7 is a user interface 130 generated by the visualizer component 64 according to one embodiment. In this example, the visualizer component 64 accessed the aggregate queries data structure 61 to visualize aggregate information regarding the datastore 14-1. The user interface 130 contains an information area 132 that indicates that five users have accessed the datastore 14-1 within a particular period of time, such as the last week. The user interface 130 includes accessor icons 134-1-134-5 (generally, accessor icons 134), each of which corresponds to one of the five accessors of the datastore 14-1, and identifies the particular accessor to which the respective icon 134 corresponds.

The accessors may be individuals, upstream services, a department or any other identifiable entity. Lines 136-1-136-5 extend from each of the accessor icons 134-1-134-5 to a datastore icon 138. Dialog boxes 140-1-140-5 correspond to the accessor icons 134-1-134-5, respectively, and identify, for each accessor, the number of sensitive records that have been accessed by the respective accessor. In this example, the line 136-5 has been selected by a user, and the dialog box 140-5, in response to the selection of the line 136-5, presents additional information identifying categorizations of the types of sensitive data classes that have been accessed, including, in this example “Type 1”, “HIPAA_18” and “PII” categories of sensitive data.

An information area 142 provides additional information regarding the accesses of the datastore 14-1 by the accessor corresponding to the accessor icon 134-5. The information area 142 indicates that 1935 records that contained PII type sensitive data classes were read, 1935 records that contained HIPAA_18 type sensitive data classes were read, 1231 records that contained anonymous type sensitive data classes were read, and 1825 records that contained non-sensitive anonymous type sensitive data classes were read.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a classifier component executing on one or more processor devices, an instruction to determine whether any data fields in a first datastore are sensitive data fields in which sensitive data is stored, the first datastore comprising a first data structure comprising a plurality of records, each record comprising a first set of data fields;
analyzing, by the classifier component, the first set of data fields and determining that at least one data field is a sensitive data field;
causing, by the classifier component, information that classifies the at least one data field as a sensitive data field to be stored in a data catalog without sending content of any data field in the first set of data fields to the data catalog;
subsequently accessing, by a data security component executing on the one or more processor devices, a query made to the first datastore, the query including a data field name that identifies the at least one data field;
determining, by the data security component based on the data catalog, that the query requested content from a sensitive data field; and
storing, by the data security component, information that the query requested the content from the sensitive data field.

2. The method of claim 1 wherein analyzing, by the classifier component, the first set of data fields and determining that the at least one data field is a sensitive data field comprises:
accessing, by the classifier component, a subset of records of the plurality of records;
determining that content stored in the at least one data field in each record in the subset of records comprises sensitive data; and
in response to determining that the content stored in the at least one data field in each record in the subset of records comprises sensitive data, determining that the at least one data field is a sensitive data field.

3. The method of claim 2 wherein determining that the content stored in the at least one data field in each record in the subset of records comprises sensitive data further comprises:
processing the content with at least one regular expression; and
determining, based on processing the content with the at least one regular expression, that the at least one data item is a sensitive data item.

4. The method of claim 1 wherein analyzing, by the classifier component, the first set of data fields and determining that the at least one data field is a sensitive data field comprises:
accessing a datastore schema that identifies data field names that correspond respectively to the data fields in the first set of data fields;
comparing the data field names to predetermined words; and
based on comparing the data field names to the predetermined words, determining that the at least one data field is a sensitive data field.

5. The method of claim 1 wherein the classifier component executes in a restricted computing environment requiring authorization to access the first datastore, and wherein the data security component executes in an environment external to the restricted computing environment and has no access to the first datastore.

6. The method of claim 1 further comprising:
prior to accessing, by the data security component, the query, obtaining, by a sensitive-data removing component executing on the one or more processor devices, the query from a query repository;
parsing, by the sensitive-data removing component, the query to identify a data field name, a parameter, and a condition with respect to the data field name and the parameter that identifies records that match the query;
removing, by the sensitive-data removing component, the parameter such that the query no longer includes the parameter; and
sending, by the sensitive-data removing component, the query to the data security component.

7. The method of claim 6 wherein the sensitive-data removing component executes in a restricted computing environment requiring authorization to access the query repository, and wherein the data security component executes in an environment external to the restricted computing environment and has no access to the query repository.

8. The method of claim 6 wherein the query repository comprises a datastore log that stores queries made to the first datastore.

9. The method of claim 6 wherein the query repository comprises a trace data structure in which, for each transaction made to an application comprising a plurality of microservices, each respective microservice in a chain of microservices stores trace records that identify an upstream microservice that invoked the respective microservice and any queries made to the first datastore by the respective microservice.

10. The method of claim 9 further comprising:
obtaining, by a validating microservice of the plurality of microservices, a security token that identifies an entity that caused the query to be made to the first datastore; and
sending, by the sensitive-data removing component to the data security component, at least a portion of the security token that identifies the entity.

11. The method of claim 6 further comprising:
obtaining, by the sensitive-data removing component, a security token that identifies an entity that caused the query to be submitted the query to be made to the first datastore; and
sending, by the sensitive-data removing component to the data security component, at least a portion of the security token that identifies the entity.

12. The method of claim 11 wherein the at least the portion of the security token identifies an individual.

13. The method of claim 1 further comprising:
causing user interface imagery that identifies a plurality of datastores associated with an entity, including the first datastore to be presented on a display device;
receiving a user input selection of the first datastore; and
sending, to the classifier component, the instruction to determine whether any data fields in the first datastore should be classified as sensitive data fields in which sensitive data is stored.

14. A computer system comprising:
one or more computing devices operable to:
receive, by a classifier component executing on one or more processor devices, an instruction to determine whether any data fields in a first datastore are sensitive data fields in which sensitive data is stored, the first datastore comprising a first data structure comprising a plurality of records, each record comprising a first set of data fields;
analyze, by the classifier component, the first set of data fields and determine that at least one data field is a sensitive data field;
cause, by the classifier component, information that classifies the at least one data field as a sensitive data field to be stored in a data catalog without sending content of any data field in the first set of data fields to the data catalog;
subsequently access, by a data security component executing on the one or more processor devices, a query made to the first datastore, the query including a data field name that identifies the at least one data field;
determine, by the data security component based on the data catalog, that the query requested content from a sensitive data field; and
store, by the data security component, information that the query requested the content from the sensitive data field.

15. The computer system of claim 14 wherein to analyze, by the classifier component, the first set of data fields and determine that the at least one data field is a sensitive data field, the one or more computing devices are further operable to:
access, by the classifier component, a subset of records of the plurality of records;
determine that content stored in the at least one data field in each record in the subset of records comprises sensitive data; and
in response to determining that the content stored in the at least one data field in each record in the subset of records comprises sensitive data, determine that the at least one data field is a sensitive data field.

16. The computer system of claim 14 wherein the classifier component executes in a restricted computing environment requiring authorization to access the first datastore, and wherein the data security component executes in an environment external to the restricted computing environment and has no access to the first datastore.

17. The computer system of claim 14 wherein the one or more computing devices are further operable to:
prior to accessing, by the data security component, the query, obtain, by a sensitive-data removing component executing on the one or more processor devices, the query from a query repository;
parse, by the sensitive-data removing component, the query to identify a data field name, a parameter, and a condition with respect to the data field name and the parameter that identifies records that match the query;
remove, by the sensitive-data removing component, the parameter such that the query no longer includes the parameter; and
send, by the sensitive-data removing component, the query to the data security component.

18. A non-transitory computer-readable storage medium that includes executable instructions operable to cause one or more computing devices to:
receive, by a classifier component executing on one or more processor devices, an instruction to determine whether any data fields in a first datastore are sensitive data fields in which sensitive data is stored, the first datastore comprising a first data structure comprising a plurality of records, each record comprising a first set of data fields;
analyze, by the classifier component, the first set of data fields and determine that at least one data field is a sensitive data field;
cause, by the classifier component, information that classifies the at least one data field as a sensitive data field to be stored in a data catalog without sending content of any data field in the first set of data fields to the data catalog;
subsequently access, by a data security component executing on the one or more processor devices, a query made to the first datastore, the query including a data field name that identifies the at least one data field;
determine, by the data security component based on the data catalog, that the query requested content from a sensitive data field; and
store, by the data security component, information that the query requested the content from the sensitive data field.

19. The non-transitory computer-readable storage medium of claim 18 wherein to analyze, by the classifier component, the first set of data fields and determine that the at least one data field is a sensitive data field, the instructions are further operable to cause the one or more computing devices to:
access, by the classifier component, a subset of records of the plurality of records;
determine that content stored in the at least one data field in each record in the subset of records comprises sensitive data; and
in response to determining that the content stored in the at least one data field in each record in the subset of records comprises sensitive data, determine that the at least one data field is a sensitive data field.

20. The non-transitory computer-readable storage medium of claim 18 wherein the classifier component executes in a restricted computing environment requiring authorization to access the first datastore, and wherein the data security component executes in an environment external to the restricted computing environment and has no access to the first datastore.
